(19) United States
(12) Patent Application Publication
(10) Pub. No.: US 2008/0222228 A1
(43) Pub. Date: Sep. 11, 2008

(54) BANK OF CASCADABLE DIGITAL FILTERS, AND RECEPTION CIRCUIT INCLUDING SUCH A BANK OF CASCADED FILTERS

(75) Inventor: Michel HALLE, Les Clayes Sous Bois (FR)

Correspondence Address: LOWE HAUPTMAN & BERNER, LLP, 1700 DIAGONAL ROAD, SUITE 300, ALEXANDRIA, VA, 22314, US

(73) Assignee: THALES, NEUILLY SUR SEINE (FR)

(21) Appl. No.: 11/963,696

(22) Filed: Dec. 21, 2007

(30) Foreign Application Priority Data
Dec. 22, 2006 (FR) 06 11266

(51) Int. Cl. G06F 17/14; G06F 17/10

(52) U.S. Cl. 708/300; 708/404

(57) ABSTRACT

The present invention relates to a bank of digital filters that can be cascade connected. It also relates to a reception circuit comprising such a bank of cascaded filters. With the digital filter being sampled at a given sampling frequency Fs, the bank of cascadable digital filters has: at the input, a frequency transposition circuit (31) for the digital signal. A polyphase filter (30) receives as input the frequency-transposed digital signal clocked at the sampling frequency Fs. The polyphase filters has an FFT filter (32) having a number N of points. The output of the filtering device retains a given number of outputs (36) of the FFT filter (32) so that the information bit rate at the output of the device is equal to the information bit rate at the input. The invention is particularly applicable to heterodyne-type radar signal receivers.

### RELATED APPLICATIONS

The present application is based on, and claims priority from, French Application Number 06 11266, filed Dec. 22, 2006, the disclosure of which is hereby incorporated by reference herein in its entirety.

### FIELD OF THE INVENTION

The present invention relates to a device for filtering a sampled digital signal forming a bank of digital filters that can be cascade connected. It also relates to a reception circuit including such a bank of cascaded filters. The invention particularly applies to heterodyne-type radar signal receivers.

### BACKGROUND OF THE INVENTION

The quality of the reception subsystem of a radar is a key factor in ensuring a good detection or interpretation of the received signals. To enhance the reception, a frequency transposition is normally performed at the input of the reception subsystem. The reception frequency is transposed into a so-called intermediate frequency to enhance the isolation of the reception subsystem. Such reception subsystems are called heterodyne or even superheterodyne.

Modern superheterodyne receivers used for the reception of radar signals can in particular be broken down into four parts:
an analog subsystem performing a transposition of the microwave signals into intermediate frequency IF, the output comprising one or more channels, the instantaneous bandwidth of which is of the order of 500 MHz for example;
an analog-digital conversion coding the IF signal by an 8 to 10-bit converter, for example, at an instantaneous rate that can be greater than 109 samples per second;
a digital processing, executed in an FPGA (Field-Programmable Gate Array) type programmable circuit, the function of which is to filter, detect and characterize the signals, this processing making it possible to measure for each radar pulse the overall parameters such as the power level, frequency, duration, time of arrival and, where appropriate, additional intra-pulse information such as frequency, phase or amplitude modulations;
a hardware and/or software subsystem handling in particular the high-level processing operations such as deinterleaving, tracking, identification or location.

The third part concerning in particular the filtering and detection functions has a specific nature which lies in particular in the very wide variety of the signals to be processed. The frequency spectrum of a radar pulse can occupy from several hundreds of kilohertz (kHz) to several hundreds of megahertz (MHz). A receiver that is optimal in the sense of the probability of detection is a receiver that has a bandwidth suited to the frequency spectrum of each signal, corresponding in fact to the optimization of the signal-to-noise ratio for each signal. To produce such an optimal receiver, it is therefore necessary for the latter to have simultaneously several banks of filters.

One known solution uses two filtering subsystems.

In a first subsystem, the filtering is performed by a programmable fast Fourier transform (FFT), comprising, for example, from 64 to 2048 points, without overlap, with a weighting law such that each output of the FFT behaves as a filter with a bandwidth at 50 dB that is approximately four times the computation frequency of the FFT. This filtering function has at least two drawbacks:
only one FFT is present at a time, so the detection is not done optimally on all the signal types;
the outputs do not comply with the Nyquist criterion, four FFTs would in fact be needed to comply with this criterion, so they do not make it possible to accurately characterize the signals detected.

A second subsystem is therefore necessary to perform in particular the fine characterizations. It is then necessary to add to the preceding subsystem a second channel of one or several digital down converters DDC. The role of these DDC filters is to effectively filter the signals in order to perform accurate measurements in the frequency and time domains. These DDC filters are driven by the spectral channel. Here too, the problem of choice of the optimal width of these DDC filters arises. The number of DDC filters is equal to the number of signals that can be acquired simultaneously, which can result in heavy and complex implementations.

### SUMMARY OF THE INVENTION

One aim of the invention is to overcome the abovementioned drawbacks by enabling in particular the optimal detection and characterization of simultaneous radar signals of all types. To this end, the subject of the invention is a device for filtering a digital signal sampled at a given sampling frequency Fs, which comprises at least:
at the input, a frequency transposition circuit for the digital signal;
a polyphase filter, clocked at the sampling frequency Fs of the incoming digital signal, receiving as input the frequency-transposed digital signal and comprising an FFT filter having a number N of points;
   the output of said filtering device retaining a given number of outputs of the FFT filter so that the information bit rate at the output of said device is equal to the information bit rate at the input.

N/2 outputs of the FFT filter are, for example, retained.

The frequency transposition circuit performs, for example, a transposition roughly equal to Fs/2N.

The frequency transposition circuit can advantageously be a complex multiplier multiplying the digital signal at the input by the complex number:

$$exp ( 2 iπ \frac{Fs}{2 N} t )$$

exp( ) representing the exponential function and t representing time.

Another subject of the invention is a signal reception circuit comprising an analog-digital conversion circuit for the received signal and a filtering circuit for the digitized received signal, comprising filtering devices as defined previously, cascade connected, each filtering device forming a stage of the cascade, the outputs of one filtering device being connected to the input of the next filtering device, all of the output filters of the different stages forming a bank of filters, at least one filter being suited to the digitized received signal.

The reception circuit comprises, for example, a detection circuit consisting of individual detection circuits, an individual detection circuit being connected to the output of the filters of each stage.

The outputs of the individual detection circuits are, for example, linked to a synthesis circuit to process the filtered signals.

Advantageously, each individual detection circuit can be linked to a stage via a delay circuit compensating the transition time of the signal in the preceding stages.

The reception circuit comprises, for example, upstream of the analog-digital conversion circuit, a frequency transposition circuit for the received signal.

Advantageously, the reception circuit is incorporated in the radar signal reception subsystem.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1, an illustration of the functions of a radar signal superheterodyne reception subsystem;

FIG. 2, an embodiment according to the prior art of the filtering functions inside this reception subsystem;

FIG. 3, an exemplary embodiment of a cascadable digital filter according to the invention;

FIG. 4, the filtering part of a reception subsystem comprising filters according to FIG. 3, cascade connected,

FIGS. 5a to 5d, illustrations of a set forming a bank of filters.

### DETAILED DESCRIPTION OF THE DRAWING

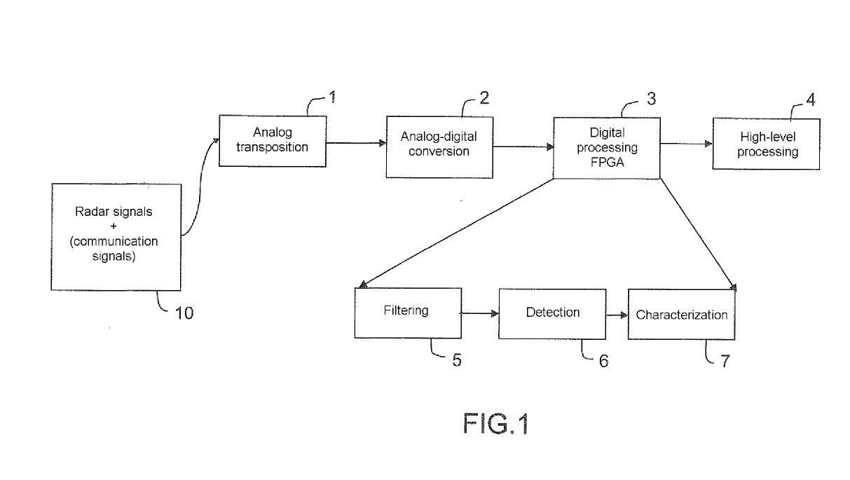

FIG. 1 illustrates the functions of a reception processing subsystem, implementing in particular the four parts described previously. Radar signals 10, for example, communication signals, are received by an analog transposition subsystem 1. In this subsystem, the frequency of the signals is transposed to an intermediate frequency IF. Then, an analog-digital conversion 2 is performed. The digital processing described previously is performed on the digitized signals. As indicated previously, this third part includes a filtering function 5 followed by a detection function 6 and a characterization function 7. Finally, the third part 3 can be followed by a fourth part 4 handling higher level functions.

One specific feature of the third part 3 lies in the very wide variety of signals to be processed which can necessitate having simultaneously a number of banks of filters, for example:

2×320 MHz filters
4×160 MHz filters
8×80 MHz filters
16×40 MHz filters
32×20 MHz filters
64×10 MHz filters
128×5 MHz filters
256×2.5 MHz filters
512×1.25 MHz filters
1024×0.625 MHz filters.

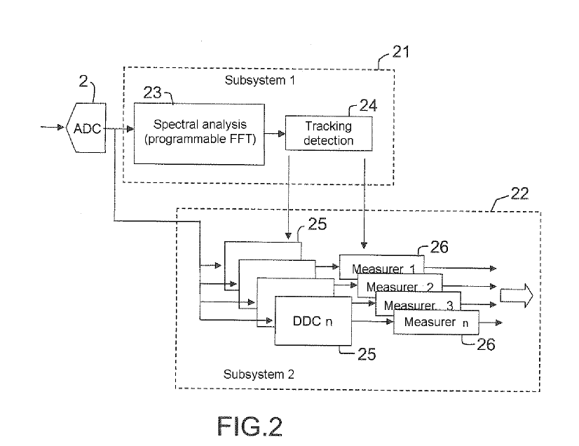

FIG. 2 illustrates one solution according to the prior art as mentioned previously. The digitized signal at the output of the converter 2 is taken into account by two filtering subsystems 21, 22. The first subsystem 21 comprises at the input a spectral analysis module 23 where a filtering is performed by programmable FFT. The filtering module is followed by a detection and tracking module 24, for example, handling the function of the fourth part 4.

In some cases, the first subsystem 21 may be sufficient, but if fine characterizations must in particular be performed, it is then necessary to add the second subsystem 22 comprising one or more DDC filters 25. These filters are followed by measurers 26 performing fine measurements on the signals isolated by the DDCs for example. The problem of the optimal width of the DDC filters arises as does the problem of their number.

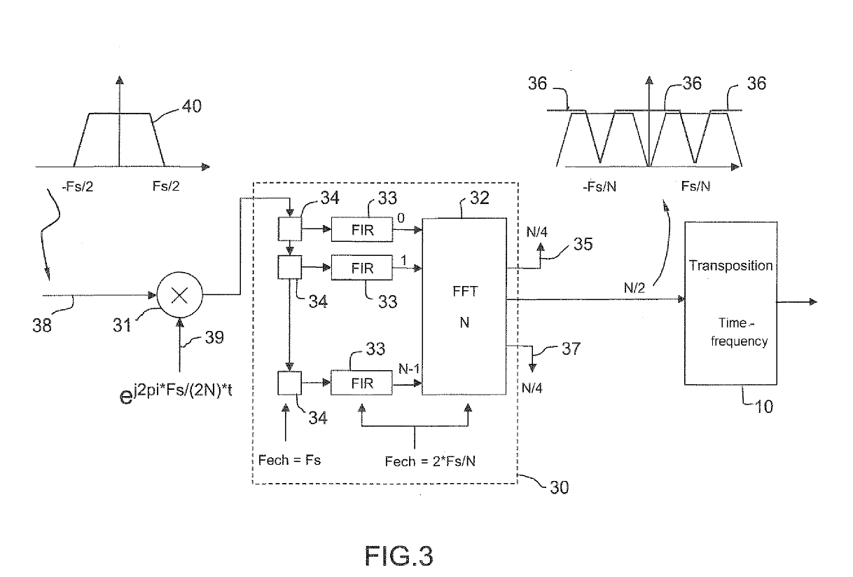

FIG. 3 illustrates the principle of implementation of a device according to the invention. In particular, it shows one exemplary embodiment of a polyphase filter according to the invention.

The invention relies in particular on a cascading of polyphase filter functions. This function subdivides an input channel having a frequency bandwidth B into N channels having a frequency width B/N at the output.

The filter of FIG. 3 comprises a polyphase filter of known type 30 equipped at the input with a frequency transposition circuit 31 and retaining at the output only half of the outputs of the filter 30.

The polyphase filter 30 comprises a fast Fourier transform FFT filtering circuit 32. An FFT filter is normally preceded by a weighting function of length equal to the number of points of the FFT where each of the coefficients is applied to each input of the FFT. A polyphase filter enhances an FFT filter with conventional weighting function by increasing the length of the weighting function, the latter being, for example, an approximation of a function of the type sin(x)/x. The principle of implementation of a polyphase filter thus relies on the use of an N-point FFT, preceded by a weighting function of length K times greater than the number of points of the FFT, K being an integer number. In the example of FIG. 3, the FFT comprises N points. The weighting coefficients are, for example, produced by N finite impulse response filters 33, also called FIR, each of these filters having a length K, that is, comprising K coefficients. A first filter 33 is assigned to the first point 0 of the FFT, a second filter is assigned to the second point 1 of the FFT and so on until a final filter which is assigned to the final point N−1 of the FFT. The outputs 35, 36, 37 of the FFT form a bank of N adjacent filters, the frequency response of which is the Fourier transform of the weighting law. The width of each filter is Fs/N, Fs being the sampling frequency of the input signal.

This polyphase filter principle makes it possible to produce very good quality filters, close to an ideal filter of rectangular appearance. As an example, for a factor K equal to 8, the polyphase filter 30 makes it possible to obtain:
an overlap of 20%;
a ripple in the bandwidth of a filter less than 0.1 dB;
a rejection outside this band greater than 50 dB;
a width at 50 dB less than 2×Fs/N.

To comply with the Nyquist criterion, a polyphase filter doubles the rate compared to the input rate. The computation frequency of the filter is in practice such that the output rate is equal to at least twice the input rate.

Thus, the computation rate of the polyphase filter is equal to 2×Fs/N, the outputs of the FFT comply with the Nyquist criterion. With this computation rate, the output information rate is doubled compared to the input rate, which gives N filters sampled at 2×Fs/N. It is not then possible to cascade such a filter.

According to the invention, only a half of the filter is, for example, retained at the output of the polyphase filter 30. In this way, the output digital rate remains equal to the input digital rate. In practice, to make the filter cascadable, that is, to be able to mount it in cascade fashion, it is essential not to double the output rate of each cascaded filter on pain of having to use too much hardware, which is almost prohibitive.

In order to make the polyphase filter cascadable, the output rate is therefore, for example, kept equal to the input rate. To this end, the invention retains for example at the output of the polyphase filter 30 only half of the filters. However, this results in a reduction of the useful bandwidth. Trials performed by the applicant have shown that this problem could be resolved by transposing the signal upstream by a half filter width, or Fs/2N in the example of FIG. 3. This transposition moreover makes it possible to retain a symmetrical filter at the output.

The transposition 31 is, for example, preformed by a complex multiplier. This circuit 31 comprises, on a first input 38, the input signal, sampled at the frequency Fs, then on a second input 39, the following complex signal:

$$C = exp ( 2 iπ \frac{Fs}{2 N} t )$$

exp( ) representing the exponential function and t representing time.

The output signal of the complex multiplier 31 is sent to the polyphase filter 30. More specifically, this signal is sent, for example, to shift registers 34 connected in series. On each clock pulse, at the sampling frequency Fs, the input digitized signal is transferred from one register to the other before being filtered by an FIR filter 33 operating at twice the sampling frequency divided by the number N of points of the FFT, or at the frequency of 2Fs/N.

The filter of FIG. 3 therefore makes it possible to obtain at the output N/2 filtering channels 36 of a width 2×Fs/N spaced by Fs/N from an input channel 40, of width Fs, allowing the input signals 38 to pass. Only the central filters 36 are, for example, retained, N/4 filters 35, 37 being rejected on each side. The rejected filters 35, 37 typically remain unused.

To make cascading possible, the outputs of the filter, comprising N/2 outputs of the FFT, are typically linked to the input of a time-frequency transposition circuit 10. This circuit makes it possible in practice to link the parallel outputs of the FFT to a serial input of a following filter cascade-connected. More particularly, the time-frequency transposition circuit is, for example, a digital memory which, at the computation frequency of the FFT:
receives as input a time sample of N/2 filters;
supplies as output N/2 time samples for one and the same filter.

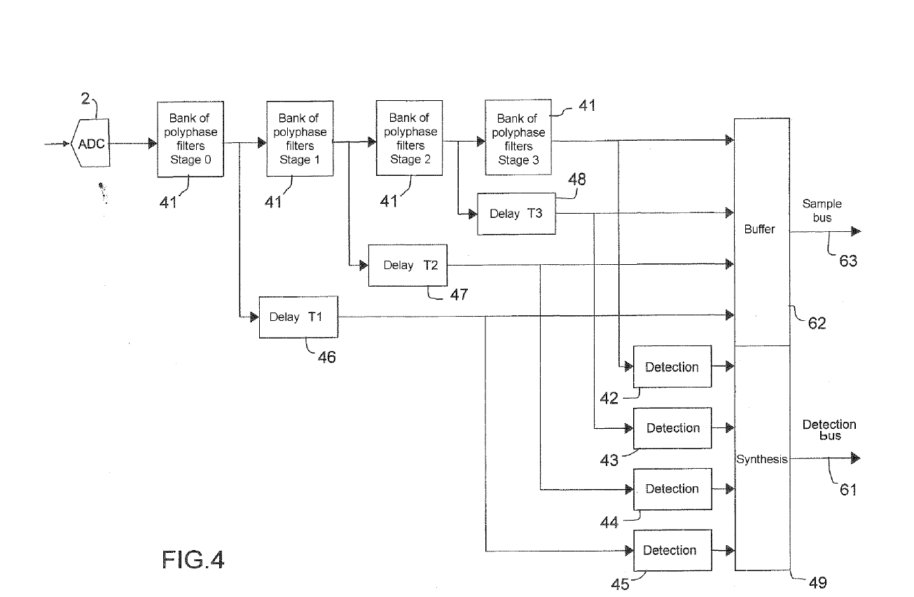

FIG. 4 illustrates one exemplary embodiment of a reception circuit according to the invention comprising the cascade-connection of filters 41 according to FIG. 3. This circuit of FIG. 4 makes it possible to produce the third stage of the receiver illustrated in FIG. 1.

In the example of FIG. 4, four filters 41 are cascade-connected. The filter therefore comprises four stages, each polyphase filter forming a stage. The first stage is a polyphase filter based on a 16-point FFT, or N=16 in this example. The latter handles the actual complex transformation, only the positive frequencies being retained. The computation frequency of this stage is 160 MHz, the sampling frequency Fs being such that:
160=2Fs/N, or Fs=1280 MHz.

At the output of the first stage, we obtain N/2=8 filters spaced by:
Fs/N=1280/16=80 MHz sampled at 160 MHz.

The following three stages are, for example, polyphase filters based on an 8-point FFT, or N=8, the computation frequencies of these stages being 320 MHz. Each output filter of the first stage therefore generates N/2=4 filters. For the eight input filters derived from the first stage, we therefore obtain 4×8=32 filters, spaced by 20 MHz and sampled at 40 MHz. At the output of the third stage, we obtain 128 filters spaced by 5 MHz and sampled at 10 MHz. Finally, at the output of the fourth stage, we obtain 512 filters spaced by 1.25 MHz and sampled at 2.5 MHz.

The four stages therefore subdivide the input channel, at the output of the converter 2, having a frequency bandwidth B in N channels having a frequency width B/N at the output. In the example of FIG. 4, with N=4, a cascade of four polyphase filters thus makes it possible to produce simultaneously:
8×80 MHz filters
32×20 MHz filters
128×5 MHz filters
512×1.25 MHz filters.

The reduction of N/2 filters results in a reduction of the spectrum according to the following relation:

$$Reduction either side of the filter = \frac{Fs}{2} ( \frac{1}{2} - \frac{1}{N} )$$

where Fs is the output sampling frequency of the preceding stage.

In the example of FIG. 4, the reduction according to the stage is given by the following table:

| Stage | Fs | N | Reduction (MHz) | Useful bandwidth (MHz) |
|---|---|---|---|---|
| 1 | 1280 | 16 | | 640 |
| 2 | 160 | 8 | 30 | 580 |
| 3 | 40 | 8 | 7.5 | 565 |
| 4 | 10 | 8 | 1.875 | 561.25 |

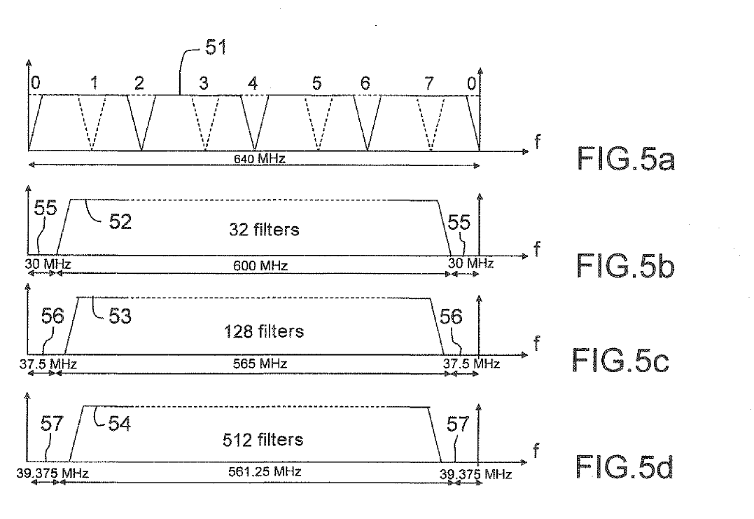

FIGS. 5a to 5d illustrate the filters obtained, still for the example of FIG. 4.

FIG. 5a illustrates by curves 51 the bandwidths of the eight filters obtained at the output of the first stage. The useful frequency band covered by these filters is of the order of 640 MHz. For this first stage, there is no spectrum reduction.

FIGS. 5b, 5c and 5d respectively illustrate by curves 52, 53, 54 all the bandwidths of the 32 filters at the output of the second stage, all the bandwidths of the 128 filters of the third stage and all the bandwidths of the 512 filters of the fourth stage. The useful band covered by these filters is of the order of 580 MHz. A spectrum reduction 55 of 30 MHz appears on the filter 52 of the second stage. A spectrum reduction 56 of 37.5 MHz appears on the filter 53 of the third stage. A spectrum reduction 57 of 39.375 MHz appears on the filter 54 of the fourth stage.

By increasing the number of stages, the useful band converges towards 560 MHz. This value is compatible with an anti-aliasing analog filter which makes it possible to limit, for example, the band to 500 MHz with a sampling frequency of 1280 MHz.

To return to FIG. 4, the output of the fourth stage is linked to the input of a first detection circuit 42. The outputs of the third, second and first stages are respectively linked to the input of a second 43, third 44 and fourth 45 detection circuit. Where appropriate, these three stages are linked to the detection circuits via delay circuits 46, 47, 48. These delay circuits offset the transition times in the various stages and thus make it possible in particular to synchronize the signals that enter into the detection circuits 42, 43, 44, 45. The outputs of the detection circuits are linked, for example, to a synthesis circuit 49, which groups together the detection information to deliver it to a bus 61. The circuit of FIG. 4 forming the processing stage 3 of FIG. 1, excluding the analog-digital converter, with at least the filtering and detection functions, the data delivered to the bus 61 are, for example, transferred by the bus itself to the fourth stage 4 of the receiver of FIG. 1 or to a characterization circuit 7 if necessary. The outputs of the filtering stages 41 are, for example, linked elsewhere, via the delay circuits 46, 47, 48, to a buffer circuit 62 intended in particular to store the signals in order to be recovered, via a bus 63, and processed, where appropriate, by other circuits.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalent thereof.

1. A device for filtering a digital signal sampled at a given sampling frequency Fs, comprising:
an, a frequency transposition circuit for the digital signal having an input;
a polyphase filter, clocked at the sampling frequency Fs of the incoming digital signal, receiving as input a frequency-transposed digital signal and comprising fast fourier transform (FFT) filter having a number N of points;
an output of said filtering device retaining a given number of outputs of the FFT filter so that the information bit rate at the output of said device is equal to the information bit rate at the input.

2. The device as claimed in claim 1, wherein N/2 outputs of the FFT filter are retained.

3. The device according to claim 1, wherein the frequency transposition circuit (31) performs a transposition roughly equal to Fs/2N.

4. The device according to claim 3, wherein the frequency transposition circuit is a complex multiplier multiplying the input digital signal by the complex number:
$$exp ( 2 iπ \frac{Fs}{2 N} t )$$
exp( ) representing the exponential function and t representing time.

5. A signal reception circuit comprising an analog-digital conversion circuit for the received signal, comprising a filtering circuit for the digitized received signal, having filtering devices according to claim 1, cascade connected, each filtering device forming a stage of the cascade, the outputs of one filtering device being connected to the input of the next filtering device, all of the output filters of the different stages forming a bank of filters, at least one filter being adapted to the digitized received signal.

6. The reception circuit according to claim 5, wherein comprising a detection circuit having individual detection circuits, an individual detection circuit being connected to the output of the filters of each stage.

7. The reception circuit according to claim 5, wherein the outputs of the individual detection circuits are linked to a synthesis circuit for processing the filtered signals.

8. The reception circuit according to claim 6, wherein each individual detection circuit is linked to a stage via a delay circuit compensating for the transition time of the signal in the preceding stages.

9. The reception circuit according to claim 5, wherein comprising upstream of the analog-digital conversion circuit a frequency transposition circuit for the received signal.

10. The reception circuit according to claim 5, wherein the reception circuit is incorporated in the radar signal reception chain.
